(19) United States
(12) Patent Application Publication
(10) Pub. No.: US 2005/0288476 A1
(43) Pub. Date: Dec. 29, 2005

(54) Thermoplastic copolymers through stoichiometric reactions between diisocyanates and oligomeric diols and diamines

(76) Inventors: Iskender Yilgor, Istanbul (TR); Emel Yilgor, Istanbul (TR); Garth L. Wilkes, Blacksburg, VA (US); Jignesh P. Sheth, Wilsonville, OR (US); Derek B. Klinedinst, Blacksburg, VA (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/153,896

(22) Filed: Jun. 16, 2005

Related U.S. Application Data
(60) Provisional application No. 60/580,253, filed on Jun. 17, 2004.

(51) Int. Cl. C08G 18/00

(52) U.S. Cl. 528/44

(57) ABSTRACT

A segmented copolymer can be produced without needing a chain extender. The conventional view that a chain extender was needed to construct a segmnented copolymer has been disproven. For example, by certain reactions of a diisocyanate with oligomeric and polymeric diols or diamines, segmented copolymers can be produced without needing a chain extender. Segmented copolymers not containing ethylene glycol, 1,4-butanediol and ethylene diamine can be produced.

### CROSS REFERENCE TO RELATED APPLICATIONS

This application claims benefit of U.S. provisional application No. 60/580,253 filed Jun. 17, 2004 entitled “Thermoplastic segmented polyurethane, polyurea, and polyurethaneurea copolymers through stoichiometric reactions between diisocyanates and oligomeric and polymeric diols or diamines.”

### STATEMENT REGARDING FUNDING

The work discussed herein was supported in part by the U.S. Army Research Laboratory and the U.S. Army Research Office under grant number DAAD19-02-1-0275 Macromolecular Architecture for Performance (MAP) Multi-University Research Initiative, and the U.S. government may have certain rights in the invention.

### FIELD OF THE INVENTION

This invention relates to segment copolymers, particularly segmented thermoplastic polyurea, polyurethane, and polyurethane ureas, and methods of producing the copolymers.

### BACKGROUND OF THE INVENTION

“Segmented” thermoplastic polyurethanes, polyurethaneureas and polyureas (TPU) are a well-known class of chemicals. As shown in formula (I) below, these TPU materials consist of high molecular weight, linear macromolecules that are based on alternating “hard” (A) and “soft” segments (B) along the polymer backbone.
(-A-B—)ₙ (I)

In general, TPUs are obtained through the reaction of excess diisocyanates with polymeric glycols (soft segments), with number average molecular weights generally between 1000 and 3000 g/mol, and low molecular weight diol or diamine chain extenders, such as ethylene glycol, 1,4-butanediol or ethylene diamine. Synthetic reactions can be performed in one step, where all ingredients are mixed and reacted, or in two steps, where an isocyanate-terminated soft segment is first prepared and subsequently chain extended with a diamine or diol. Hard segments can be urethane, urea or urethaneurea which can be obtained through the reaction of diisocyanates with low molecular weight diols, diamines, or amino alcohols respectively. Soft segments are usually aliphatic polyethers or aliphatic polyesters. Morphology, physical and chemical properties, performance and applications of these materials strongly depend on the chemical composition of the backbone, type, nature, average molecular weight and amount of hard and soft segments, overall molecular weight of the copolymer and processing conditions and thermal history.

Segmented block copolymers are widely used in several industries including automotive coatings, molded components, sporting goods manufacturing, and in the insulation business. The breadth in the applications for these materials can be attributed in part to their wide range of mechanical and thermal properties. Because these properties in certain ways can be controlled and even tailored to a specific end use makes segmented copolymers a very attractive class of materials.

Segmented TPUs are a subclass of linear segmented copolymers possessing a backbone comprised of alternating “soft” segments (SS) and “hard” segments (HS). These segments typically have rather low molecular weights compared to triblock copolymers, such as the styrene-butadiene-styrene (SBS) systems, which generally possess block molecular weights of 10,000-100,000 g/mol and are prepared by anionic polymerization. Abouzahr S, Wilkes G L, Segmented Copolymers with Emphasis on Segmented Polyurethanes (in: Folkes M J, editor. Processing, Structure and Properties of Block Copolymers. London: Elsevier Applied Science Publishers, 1985), pp. 165-207; Tyagi D, Wilkes G L, Morphology and Properties of Segmented Polyurethane-urea Copolymers prepared via t-Alcohol “Chain Extension” (in: Lal J, Mark J E, editors, Advances in Elastomers and Rubbery Elasticity. New York: Plenum Press, 1986), pp. 103-28.

The soft segments in TPUs are often, but not exclusively, polyethers or polyesters and are chosen based on desired functionality, reactivity and molecular weight. In TPUs, the hard segment, also low in molecular weight, is typically formed from the reaction of a diol or diamine chain extender with excess diisocyanate. The isocyanates are either aromatic or aliphatic and the choice is based on a number of factors including cost and reactivity. The specific chemistry and symmetry of the isocyanate has been shown to affect ultimate properties of the materials, and careful consideration must be given to this choice. Gisselfaelt K, Helgee B, Macromolecular Materials and Engineering 2003;288(3):265-71; Singh A, Advances in Urethane Science and Technology 1996;13:112-39.

Diamines are common “chain extender” molecules used in the synthesis of urea linkages, although other moieties such as water can also be used as is common in the production of “polyurethane” flexible foams. Oertel G, Polyurethane Handbook: chemistry, raw materials, processing, application, properties (New York: Munich: Hanser Publishers), 1985.

Linear polyurethaneureas are synthesized using a step growth reaction technique first developed by Otto Bayer in the late 1930's. Oertel, supra. In the more commonly used prepolymer method, linear hydroxyl terminated oligomeric polyether or polyesters are reacted with an excess of a selected diisocyanate to cap the oligomer thereby forming a urethane linkage and leaving an isocyanate functional group at each terminus, forming what is termed a “prepolymer”. This prepolymer mixture (containing excess diisocyanate) is then reacted with a diamine chain extender to form the hard segments and increase the molecular weight of the macromolecule. In general, an increase in HS content leads to increased modulus (stiffness) and enhanced tensile strength. Kazmierczak M E, Fornes R E, Buchanan D R, Gilbert R D, Journal of Polymer Science, Part B: Polymer Physics 1989;27(11):2173-87.

The wide range of properties of segmented copolymers is credited to microphase-separation, the process whereby hard segments segregate, forming hard microdomains in a matrix of soft segments. These microdomains are generally well dispersed throughout the soft segment matrix and act as physical crosslinks adding modulus, stiffness and strength. In block copolymer materials with non-specific interactions, an examination of the Flory-Huggins parameter helps define under what conditions microphase-separation will occur. Bates F S, Fredickson G H, Physics Today, 1999, p 32-38. However, in certain cases, such examination of the Flory-Huggins parameter is not easily applied.

Step-growth copolymers, of which polyurethanes and polyurethaneureas are widely-used commercial examples, are generally synthesized by a two-step route, commonly referred to as the ‘prepolymer’ method. Hepburn C, Polyurethane elastomers (New York: Elsevier Applied Science), 1992. In the first step, a prepolymer is made by end-capping a difunctional oligomer with excess diisocyanate. In the second step, the HS are formed by reacting the prepolymer mixture with stoichiometric amounts of a difunctional chain extender. Over the years consensus developed amongst practitioners that lengthening the HS, which of course also increases the HS content, is necessary to produce segmented copolymers that display useful structural properties in their service window. Therefore, few reports in the literature have addressed segmented copolymers that are non-chain extended, the most noteworthy being the report by Tyagi et al. (Tyagi D, McGrath J E, Wilkes G L, Poly Eng Sci 1986; 26: 1371-1398) on polydimethylsiloxane based polyurea copolymers. However, a percolated hard phase, such as could be produced by hard segment crystallinity or hydrogen bonding, was not observed visually or reconfirmed by any other method irrespective of the hard segment content (6-22 wt %) investigated.

Segmented copolymers in which crystallizable HS of uniform (monodisperse) length are synthesized before condensing them with a selected SS generally have required multi-step synthesis and have been expensive to produce. Therefore, they have received limited attention. Harrell Jr L L, Macromolecules 1969; 2: 607-612; Samuels S L, Wilkes G L, J Poly Sci Poly Symp 1973; 43: 149-178; Aneja A, Wilkes G L, Polymer 2003; 44: 7221-7228; Sauer B B, Mclean R S, Gaymans R J, Niesten M C J E, J Poly Sci, B: Poly Phy 2004; 42: 1783-1792.

The field of block and segmented copolymers is well established, and many systems have been commercialized, particularly as thermoplastic elastomers (TPEs). Thermoplastic Elastomers (Munich: Hanser Publishers) 1996; Noshay A, McGrath J E, Block Copolymers: Overview and Critical Survey (New York: Academic Press) 1977; Nylon Plastics Handbook (Cincinnati: Hanser/Gardner Publishers), 1995; Sheth J P, Xu J, Wilkes G L. Polymer 2002;44(3):743-56. Some of the most noteworthy systems are the anionically polymerized ABA tri-block materials—the initial ones which were either based on styrene (S) and butadiene (B) or S and isoprene (I) which promoted the well known and versatile TPE's often designated as SBS or SIS respectively. A wide compositional range of these and other chemically different tri- or multi-block anionically prepared systems have been well addressed in the literature along with other modifications based on architectural changes as well, such as those of the radial block type. Thermoplastic Elastomers, supra; Noshay et al., supra.

Some of the well-known attributes of the anionic block copolymers are the high level of control for achieving narrow polydispersity of the respective blocks, as well as the total molecular weight of the tri-block copolymer itself. Furthermore, typically the former values often are in the range of several thousand at the low end to tens of thousands at the upper end. Considerable theoretical strides have also been made that well describe the type of equilibrium microphase separated morphologies and order-disorder thermal transition behavior that arise in these materials due to compositional variation. Detailed studies on the understanding of the level of block-block compatibility as accounted for by the well known Flory Huggins Chi parameter have also been performed. Bates F S, Fredickson G H, in Physics Today, 1999, p 32-38; Hamley I W, The Physics of Block Copolymers (Oxford: Oxford University Press), 1998; Bates F S, Fredrickson G H, Block Copolymer Thermodynamics: Theory and Experiment, in Holden G, Legge N R, Quirk R P, Schroeder H E, editors, Thermoplastic Elastomers. Munich: Hanser Publishers, 1996, pp. 335-64; Leibler L., Macromolecules 1980;13:1602; Helfand E, Wasserman Z R, in Aggarwal S L, editor, Block Polymers (New York: Plenum Press, 1970); Mori K, Hasegawa H, Hashimoto T. Polymer Journal (Tokyo, Japan) 1985; 17(6):799-806; Block Copolymers: Science and Technology (New York: MMI Press by Harwood Academic Publishers), 1983.

As a result of the narrow block polydispersity, extremely long range order can be easily induced in these systems as has been verified by many researchers. Thermoplastic Elastomers, supra; Noshay et al., supra; Abouzahr S, Wilkes G L. Segmented Copolymers with Emphasis on Segmented Polyurethanes, in Folkes M J, editor, Processing, Structure and Properties of Block Copolymers (London: Elsevier Applied Science Publishers), 1985, pp. 165-207; Park C, Yoon J, Thomas E L, Polymer 2003; 44(25):7779; Park C, Yoon J, Thomas E L. Polymer 2003;44(22):6725-60; Villar M A, Rueda D R, Ania F, Thomas E L. Polymer 2002;43(19):5139-45; Albalak R J, Thomas E L, Capel M S. Polymer 1997;38(15):3819-25; Ophir Z, Wilkes G L. Journal of Polymer Science, Part B: Polymer Physics 1980; 18:1469-80; Wilkes G L, Abouzahr S. Macromolecules 1981;14:456.

In contrast to the anionic block copolymers described in the preceding paragraphs, segmented copolymers, which also are very important industrially, are much less susceptible to precise theoretical descriptions with respect to the specification of a narrow range order-disorder thermal transition. Furthermore, the long-range order or microphase morphological features in these systems are not as fully understood.

Examples of segmented copolymer materials are the well-known thermoplastic polyurethanes, TPUs, as well as the common segmented urethane-urea of Lycra™ spandex. Lycra™ is presently processed from solution due to the considerable level of bidentate hydrogen bonding that occurs between the hard segments (HS) in this particular material Polymers in Medicine and Surgery (New York: Plenum Press, 1975); O'Sickey M J, Lawrey B D, Wilkes G L, Polymer 2002;43(26):7399-408; O'Sickey M J, Lawrey B D, Wilkes G L, Journal of Applied Polymer Science 2002;84(2):229-43.

It should be appreciated that different classes of copolymers behave differently in certain ways. For example, a major difference between segmented copolymers and anionically polyermized tri-block copolymers is that the segment molecular weights are typically much lower than those of the anionically polymerized tri-block copolymers—in fact, usually the segment molecular weights are less than 3,000 g/mol. Furthermore, polarity often occurs in both the hard and soft segments giving rise to the potential solubility/miscibility of one segment within that of the other, particularly if the molecular weights of the respective segments are low. As a result, investigating the degree of segmental mixing has been a major focal point in many of the TPU systems. O'Sickey et al. (Polymer 2002), supra; O'Sickey et al. (Journal), supra; Abouzahr S, Wilkes G L, Ophir Z. Polymer 1982;23:1077-86; Garrett J T, Xu R, Cho J, Runt J. Polymer 2003;44(9):2711-19; Mpoukouvalas K, Floudas G, Zhang S H, Runt, J. Macromolecules 2005;38(2):552-60; Zhang S H, Jin X, Painter P C, Runt, J. Polymer 2004;45(11):3933-42; Zhang S H, Casalini R, Runt J, Roland C M, Macromolecules 2003;36(26):9917-23; Estes G M, Cooper S L, Tobolsky A V, Journal of Macromolecular Science, Reviews of Macromolecular Chemistry 1970;4(2):313; Cooper S L, Tobolsky A V, Journal of Applied Polymer Science 1966; 10:1837.

With specific regard to the segmented polyurethanes as well as urethane-ureas already mentioned, to minimize the formation of particularly short hard segments, chain extenders conventionally are used to lengthen the average hard segment size. For the case of TPUs, one of the most common chain extender is that of 1,4-butanediol while in segmented urethane-ureas as Lycra™ spandex, the chain extender is typically a low molecular weight diamine such as ethylene diamine (EDA). The present inventors know of no commercial TPU or urethane-urea segmented systems that are prepared without the use of chain extenders.

In an early study by some of the present inventors, attempts were made, in the laboratory, to promote certain non-chain extended materials. Namely, segmented polydimethylsiloxane (PDMS) ureas, amides and imides were prepared in the laboratory by using amine endcapped PDMS oligomers that were reacted with diisocyanates, diacids or dianhydrides, respectively, but without any use of chain extender moieties. Tyagi D, Wilkes G L, Yilgor I, McGrath J E. Polymer Bulletin 1982;8(11-12):543-50; Yilgor I, Sha'aban A K, Steckle W P, Jr., Tyagi D, Wilkes G L, McGrath J E. Polymer 1984;25(12): 1800-06. In the mid-1980s, the PDMS-urea and PDMS-amide systems, due to their strong hydrogen bonding capacities, were then thought likely to provide materials with reasonably good mechanical properties. Microphase separation was verified by the techniques of DSC, DMA and SAXS but required that the PDMS soft segment molecular weight be at least 1000 g/mol or higher or otherwise major hard/soft segmental mixing occurred. Tyagi D, McGrath J E, Wilkes G L. Polymer Engineering Science 1986; 26(20):1371-98. However, while the low temperature Tg of PDMS typically defined the onset of the service window for elastomeric behavior, the upper end of this window where the hard segment phase undergoes softening generally begins distinctly below 100° C. This result suggested that a single molecular hard segment (monodisperse) of this type prepared without chain extenders, would not possess sufficient hard segment-hard segment cohesiveness to allow these materials to possess a sufficiently high softening point needed for practical applications. After the publication of that work on polydimethylsiloxane containing segmented polyureas in the 1980s (I. Yilgor, J. S. Riffle, G. L. Wilkes and J. E. McGrath, Siloxane-Urea Segmented Copolymers: I. Synthesis and Characterization of Model Polymers from MDI and α,ω-Bis(Aminopropyl)Polydimethylsiloxane, Polym. Bull., 8, 535-542 (1982); D. Tyagi, G. L. Wilkes, I. Yilgor and J. E. McGrath, “Siloxane-Urea Segmented Copolymers: II. Investigation of Mechanical Behavior”, Polym. Bull., 8, 543-550 (1982); I. Yilgor, A. K. Sha'aban, W. P. Steckle, Jr., D. Tyagi, G. L. Wilkes and J. E. McGrath, Segmented Organosiloxane Copolymers: I. Synthesis of Siloxane-Urea Copolymers, Polymer, 25(12), 1800-1806 (1984); D. Tyagi, I. Yilgor, J. E. McGrath and G. L. Wilkes, Segmented Organosiloxane Copolymers: 2. Thermal and Mechanical Properties of Siloxane-Urea Copolymers, Polymer, 25(12), 1807-1816 (1984)), “single molecule” hard segment studies seem not to have been not pursued.

### SUMMARY OF THE INVENTION

The invention, in a preferred embodiment, provides a segmented thermoplastic polyurea, polyurethane, or polyurethane urea, made by the process of reacting in the absence of chain extenders stoichiometric amounts of

(a) one or more hydroxyl or amine end capped polymeric or oligomeric soft segments which lack siloxane (such as, e.g., polymeric or oligomeric soft segments that include at least one aliphatic polyether; polymeric or oligomeric soft segments that include at least one aliphatic polyester glycol; polymeric or oligomeric soft segments that include one or more of poly(ethylene oxide), poly(propylene oxide), poly(tetramethylene oxide; a polyalkene (such as telechelic, hydroxyl or amine terminated polybutadiene or polyisobuylene) or polyalkane (such as telechelic, hydroxyl or amine terminated, hydrogenated polybutadiene) soft segment; and other soft segments), and combinations thereof; polymeric or oligomeric soft segements that have a number average molecular weight ranging from 500 to 2500 g/Mol; polymeric or oligomeric soft segments that include polydimethylsiloxane having a number average molecular weight ranging from 7,000 to 12,000 g/mole; hydroxyl or amine end capped polymeric or oligomeric soft segments that have the general formula HO—(R—O—)ₓ—H, H₂N—R₁—(R—O—)ₓ—NH₂, or HR₃N—R₂—(R—O—)ₓ—R₂—NR₃H, where R, R₁, R₂ and R₃ are the same or different from each other and each are linear or branched alkyls having 2 to 20 carbon atoms, and where x ranges from 5 to 300; hydroxyl or amine end capped polymeric or oligomeric soft segments that have the general formula HO—R₄—(O—CO—R₅—CO—O—R₄)_{y}—OH where R₄ and R₅ may be the same or different and represent linear or branched alkyls with 2 to 20 carbon atoms, and where x ranges from 5 to 300; hydroxyl or amine end capped polymeric or oligomeric soft segments that have the general formula HO—(CH₂)ₓ—(CO—(CH₂)ₓ—O—)_{y}H where x ranges between 2 and 10, and where y ranges between 5 and 300; hydroxyl or amine end capped polymeric or oligomeric soft segments that include at least one hydroxyl end capped polymeric or oligomeric soft segment and at least one amine end capped polymeric or oligomeric soft segment (such as, e.g., one or more hydroxyl or amine end capped polymeric or oligomeric soft segments that includes a polydimethylsiloxane, and at least one of a poly(ethylene oxide), a poly(proprylene oxide), and a poly(tetramethylene oxide)); etc.), with

(b) one or more single molecule, non-polymeric, non-oligomeric aromatic or aliphatic diisocyanates (such as, e.g., aromatic or aliphatic diisocyanates having the general structure OCN—R—NCO, where R is an alkyl, aryl, or aralkyl moiety having 4-20 carbon atoms; an aliphatic diisocyanate selected from the group consisting of 1,4-cyclohexyldiisocyanate, bis(4-isocyanatocyclohexyl)-methane, 1,6-hexamethylene diisocyanate, and isophorone diisocyanate; an aromatic diisocyanate selected from the group consisting of p-phenylene diisocyanate, m-phenylene diisocyanate, 1,3-Bis(isocyanatoisopropyl)benzene, 2-4-tolylene diisocyanate, 2,6-tolylene diisocyanate, 4,4′-phenylene diisocyanate, and naphthalene diisocyanate, etc.).

The reaction forms polyurea or polyurethane hard segments directly adjacent to polymeric or oligomeric soft segments. In the inventive segmented thermoplastic polyurea, polyurethane, or polyurethane urea, preferably said polyurea or polyurethane hard segments constitute 5% or less by weight of said segmented thermoplastic polyurea, polyurethane or polyurethane urea.

In another preferred embodiment, the present invention provides a method of forming segmented thermoplastic polyurea, polyurethane, or polyurethane urea, comprising the step of reacting in the absence of chain extenders stoichiometric amounts of one or more hydroxyl or amine end capped polymeric or oligomeric soft segments which lack siloxane with one or more single molecule, non-polymeric, non-oligomeric aromatic or aliphatic diisocyanates, whereby polyurea or polyurethane hard segments are formed directly adjacent to polymeric or oligomeric soft segments. Preferably the reacting step is performed (a) in the presence of a solvent; (b) using batch or reactive extrusion processes; and/or (c) in an inert atmosphere. The inventive method may further comprise one or more of the following: a step of monitoring for the disappearance of an isocyanate peak in an infra red spectrum; a step of heating during said reacting step; a step of mechanically agitating a reaction mixture during said reacting step; etc.

### BRIEF SUMMARY OF THE DRAWINGS

FIGS. 1A-1D are tapping-mode AFM phase images at 200 nm for PTMO1k/PPD1/Urethane (FIG. 1A); PTMO1k/PPD1/Urea (FIG. 1B); PTMO1k/HD1/Urethane (FIG. 1C); PTMO1k/HD1/Urea (FIG. 1D); and PTMO1k/MD1/Urea (FIG. 1E).

FIGS. 2A-D are graphs of dynamic mechanical behaviors of homologous segmented polyureas and polyurethanes, with the diisocyanate constant and using different PTMO soft segments which are: PPDI based copolymers (FIG. 2A); HDI based copolymers (FIG. 2B); MPDI based copolymers (FIG. 2C); and MDI based copolymers (FIG. 2D).

FIG. 3 is a reaction scheme for the synthesis of segmented polyurethane and polyurea copolymers consisting of HS based on only a single diisocyanate. The —OH and —NH₂ terminated PTMO have <Mₙ> of 975 and 1100 g/mol respectively. Monodentate and bidentate hydrogen bonding, which arise from urethane and urea linkages respectively, are also shown.

FIG. 4 shows dynamic mechanical analysis behavior of copolymer films cast from 20 wt % solution in DMF. The tests were conducted under a nitrogen blanket by quenching the samples from ambient temperature to −130° C. and thereafter heating them at 2° C./min at 1 Hertz.

FIG. 5 shows mechanical hysteresis behavior of the sample PTMO-pPDI-U. The test was conducted at a crosshead speed of 25 mm/min on a dog-bone shaped sample having a gauge length of 10 mm. The second cycle was initiated immediately upon the completion of the first.

FIG. 6 shows ambient temperature tapping-mode atomic force microscopy phase images of copolymer films cast from 20 wt % solution in DMF. FIG. 6A is for PTMO-pPDI-U; FIG. 6B is for PTMO-pPDI-Ur; and FIG. 6C is for PTMO-mPDI-Ur. The above images were captured at a set point ratio of 0.6. Note: The imaging tip in tapping mode AFM probes not just the free surface of a given sample but also the region a few nanometers underneath the free surface. This is the reason why the above phase images possess a higher percentage of bright regions than might be expected in a sample with 14 wt % hard segment content.

### DETAILED DESCRIPTION OF THE PREFERRED EMBODIMENTS OF THE INVENTION

The present invention provides segmented copolymers (such as, e.g., TPUs, etc.) which do not contain “chain extenders,” such as, for example, ethylene glycol-free segmented copolymers; 1,4-butanediol-free segmented copolymers; ethylene diamine-free segmented copolymers; etc.

Chain-extender-free segmented copolymers may be made by inventive production methods avoiding use of chain extenders (such as ethylene glycol, 1,4-butanediol, and ethylene diamine). For example, chain-extender-free segmented copolymers may be obtained through stoichiometric reaction of a diisocyanate and an amine-terminated or hydroxy-terminated telechelic soft segment polymer or oligomer (such as a polyether, polyester, polysiloxane or polyalkane). The microphase morphology and overall properties of the segmented copolymer is strongly dependent on the chemical structure, rigidity and the symmetry of the diisocyanate, end group type (amine or hydroxy) and number average molecular weight of the soft segment.

Both aliphatic and aromatic diisocyanates can be used for the preparation of elastomeric TPUs by this approach. Symmetric diisocyanates with fairly compact structures, such as p-phenylenediisocyanate (PPDI), 1,4-cyclohexane diisocyanate (CHDD) and 1,6-hexamethylene diisocyanate usually lead to the formation of strong elastomers with well-defined microphase morphologies. Low to medium molecular weight oligomers, such as hydroxy or amine terminated polyethers (e.g. poly(tetramethylene oxide) (PTMO), poly(ethylene oxide) (PEO) or poly(propylene oxide) (PPO) and polydimethylsiloxane (PDMS)) with number average molecular weights in 500 to 2000 g/mol also lead to the formation of elastomers. Interestingly, copolymers with useful elastomeric properties can also be obtained by stoichiometric reactions of aliphatic or aromatic, symmetric or unsymmetric (e.g., HDMI, PPDI, TDI, MDI, DHDI, HDI, etc.) diisocyanates with amine terminated PDMS oligomers with Mₙ values between 7,000 and 12,000 g/mol, which has urea hard segment contents of as low as 1.4 percent by weight. Amine-terminated polymers or oligomers leading to the formation of segmented polyurea copolymers display better thermal and mechanical properties compared to the analogous urethane systems obtained from the hydroxy terminated oligomers. In addition to polyurethanes and polyureas, it is possible to use polymers or oligomers of similar (e.g. PTMO) or different (e.g. PTMO and PDMS) backbone structures but with different reactive end groups (e.g. one with hydroxy and the other with amine) to obtain polyurethaneureas. Average molecular weights of the polymers or oligomers used may be the same or different depending on the properties targeted.

Examples of the diisocyanates useable in the invention are, e.g., aromatic diisocyanates and aliphatic diisocyanates for the preparation of segmented polyurethanes, polyureas or polyurethaneureas. Aromatic diisocyanates include but not limited to, p-phenylene diisocyanate (PPDI), m-phenylene diisocyanate (MPDI), 1,3-Bis(isocyanatoisopropyl)benzene, 2,4-tolylene diisocyanate, 2,6-tolylene diisocyanate or their mixtures (TDI), 4,4′-phenylene diisocyanate (MDI) and naphthalene diisocyanate (NDI). Aliphatic diisocyanates include, but not limited to 1,4-cyclohexyldiisocyanate (CHDI), bis(4-isocyanatocyclohexyl)methane (HMDI), 1,6-hexamethylene diisocyanate (HDI), and isophorone diisocyanate (IPDI).

Examples of the soft segments useable in the invention are, e.g., α,ω-Dihydroxy or α,ω-diamino terminated aliphatic polyethers, such as poly(tetramethylene oxide), poly(ethylene oxide), poly(propylene oxide), and/or their copolymers, which can be described by the general formula (II-a-c) below, where R indicates linear or branched alkyl radicals and R₁, R₂ and R₃ indicate linear or branched alkyl or alkoxy radicals with 2 to 20 carbon atoms. (x) is usually between 10 and 200, preferably between 20 and 100 (the value of x may vary depending on the application and may range from 5 to 300). Hydroxy and amine end groups can be primary or secondary.
HO—(R—O—)ₓ—H (II-a)
H₂N—R₁—(R—O—)ₓ—R₁—NH₂ (II-b) 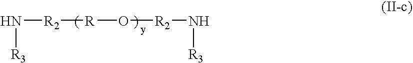
Aliphatic polyester glycols which can be described by the general formula (H) below obtained by condensation reactions of diols and dicarboxylic acids (such as poly(butylene adipate), poly(neopentyl adipate), poly(butylene hexanoate, etc.), can also be used as the soft segments, where R₄ and R₅ represent linear or branched alkyl radicals with 2 to 20 carbon atoms. (x) is usually between 10 and 100 (but can range from 5 to 300). 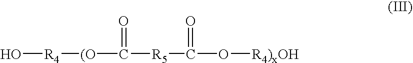
Aliphatic polyester glycols which can be described by the general formula (IV) below are obtained by ring opening polymerization reactions (such as polycaprolactone, etc.), are also useable as the soft segments where (x) can be between 3 and 7 and (x) between 10 and 100 (but can range from 5 to 300). 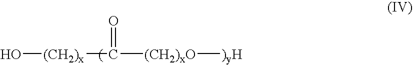
α,ω-Dihydroxy or α,ω-diamino terminated polyalkanes, such as polyisobutylene or those obtained by the hydrogenation of polybutadiene or polyisoprene are also examples of soft segment materials, and are preferred for forming strong elastomers.

Segmented polyurethane, polyurea or polyurethaneurea elastomers can be synthesized using bulk (batch or reactive extrusion processes) or solution polymerization at quantitative yields. Examples for each system are as follows.

A batch procedure for segmented polyurethanes is as follows. Equimolar amounts of the diisocyanate and the soft segment polyol are weighed into the reaction flask and stirred under nitrogen atmosphere to obtain complete mixing. If the isocyanate used is aliphatic, such as HMDI, CHDI, IPDI, etc., a small amount of catalyst, such as 50-500 ppm of dibutyltin dilaurate (DBTDL or T-12) or tin octoate (T-8) or others are added into the mixture. The system is heated up to 60-100° C. and kept there until the complete disappearance of the strong isocyanate peak around 2270 cm⁻¹ in the IR spectrum. If a solution process is preferred, a suitable polyurethane solvent (depending on the chemical structure or the nature of the soft segment), such as toluene, dimethylformamide (DMF), tetrahydrofuran (THF), their mixtures or others can be added into the system.

A solution based procedure for segmented polyureas is as follows. Due to very fast reaction rates and formation of strong urea groups it is generally not possible to use a batch process for the preparation of segmented polyureas. The preferred method is solution polymerization or reactive extrusion (discussed below). In solution polymerization, the diisocyanate is introduced into the reactor equipped with an overhead stirrer; nitrogen inlet and addition funnel and dissolved in a proper solvent such as DMF or THF. If aliphatic diisocyanates are used it is also possible to use isopropyl alcohol (IPA) as the reaction solvent or as a co-solvent together with THF and DMF especially when the reaction temperatures are between 0° C. and room temperature or 23° C. This is due to the very slow reactivity of EPA with isocyanates at these temperatures when compared with the reactivity of aliphatic amines and isocyanates, which are 3-5 orders of magnitude higher. An equimolar amount of amine terminated soft segment oligomer is separately dissolved in the desired solvent and introduced into the addition funnel. The polymerization reaction is carried out between 0 to 25° C. (depending on the diisocyanate and the solvent used) by the dropwise addition of the amine solution into the diisocyanate solution under strong agitation. Reactions are followed by FTIR spectroscopy monitoring the disappearance of the strong isocyanate peak around 2270 cm⁻¹.

Segmented polyurethaneureas can be synthesized by using a single diisocyanate but two different types of oligomers, a hydroxy and an amine terminated soft segment oligomer (of desired molecular weights and ratios). Reactions are conducted in two steps. In the first step hydroxy terminated oligomer is reacted with the diisocyanate in bulk or in solution at 60-100° C. as described before. The second step is always conducted in solution between 0-25° C. by the dropwise addition of the amine terminated oligomer into the reactor from an addition funnel. Completion of the reactions is determined by FTIR spectroscopy monitoring the disappearance of the strong isocyanate peak around 2270 cm⁻¹.

Reactive extrusion methods may be used as follows. All of the segmented copolymers (polyurethane, polyurea and polyurethaneurea) can be synthesized in a twin-screw extruder, with proper screw design for reactive extrusion and equipped with precision feed pumps and ports. For the preparation of polyurethanes equimolar amounts of diisocyanate and polyol (containing proper amount of catalyst if the diisocyanate is aliphatic in nature) can be fed into the extruder simultaneously from different pumps and reacted at temperatures between 175-200° C. For the preparation of polyureas equimolar amounts of diisocyanate and amine terminated oligomers can be fed into the extruder simultaneously from different pumps and reacted at temperatures between 175-250° C. For the preparation of polyurethaneureas diisocyanate and desired amount of polyol (containing proper amount of catalyst if the diisocyanate is aliphatic in nature) can be fed into the extruder simultaneously from different pumps and reacted at temperatures between 175-200° C. in the first few zones. Remaining amine terminated oligomer is then fed into the extruder through a different pump and reacted between 200-250° C. Depending on the screw design, barrel configuration and screw speed, extrusion times are usually between 1 and 3 minutes at these temperatures for an extruder with a barrel length-to-diameter ratio (l/d) of 24 to 42. Reactions are followed by FTIR spectroscopy monitoring the disappearance of the strong isocyanate peak around 2270 cm⁻¹ in the final product coming out of the extruder.

In the invention, no chain extenders need to be used in forming segmented copolymers. Inventive polyether-ureas are provided which, as desired, advantageously (1) can be thermally processible or moldable without degradation; and/or (2) usually display low melt viscosities (compared with conventional segmented TPUs). The invention also makes possible single hard segment TPUs that display very good mechanical properties.

Some preferred examples of uses of the present invention are as follows. Products of the invention may be used as and in specialty polyurethane foams. The invention also may be used to provide very low modulus (soft), high strength, unfilled or filled thermoplastic silicone-urea based biomaterials.

The invention may be appreciated from the following examples, which are by way of illustration and the invention is not limited thereto.

### INVENTIVE EXAMPLE 1

Samples were prepared as follows. Sample films were cast from a 10 wt % dimethyl formamide (DMF) solution. A given sample solution was cast in a Teflon® mold. The solvent was removed by placing a mold in an oven at 60° C. for ca. 4 hours and thereafter under vacuum at room temperature for 2-3 days. These solution cast films were utilized to conduct tapping-mode atomic force microscopy (AFM), dynamic mechanical thermal analysis (DMTA), differential scanning calorimetry (DSC), and tensile testing. Film thicknesses were usually around 1.00±0.2 mm. The testing procedures were as follows.

Tapping-Mode Atomic Force Microscopy

The tapping-mode AFM phase images of the free surface of solution cast films were captured using Veeco Dimension 3000® AFM with Nanoscope® III controller. TAP 150® tips, purchased from Veeco, having an average spring constant of 5 N/m were used. A set-point ratio of 0.3 to 0.6 was used to capture the images.

Dynamic Mechanical Thermal Analysis

A Seiko DMTA model DMS 210® was used to conduct the DMTA tests on rectangular samples 10 mm long and 3-5 mm wide. A given sample was quenched to −130° C. with liquid nitrogen and thereafter subjected to a heating run @ 2° C./min and a frequency of 1 Hz.

Tensile Testing

Ambient temperature tensile test of the solution cast films were conducted using Instron 4400R tensile tester and a 100 kgf load cell. Dog-bone shaped samples with a gauge length of 10 mm and width of 2.9 mm were used. A crosshead speed of 25 mm/min. was used. Minimum of three dog-bone samples were tested for each material.

Polymer Properties

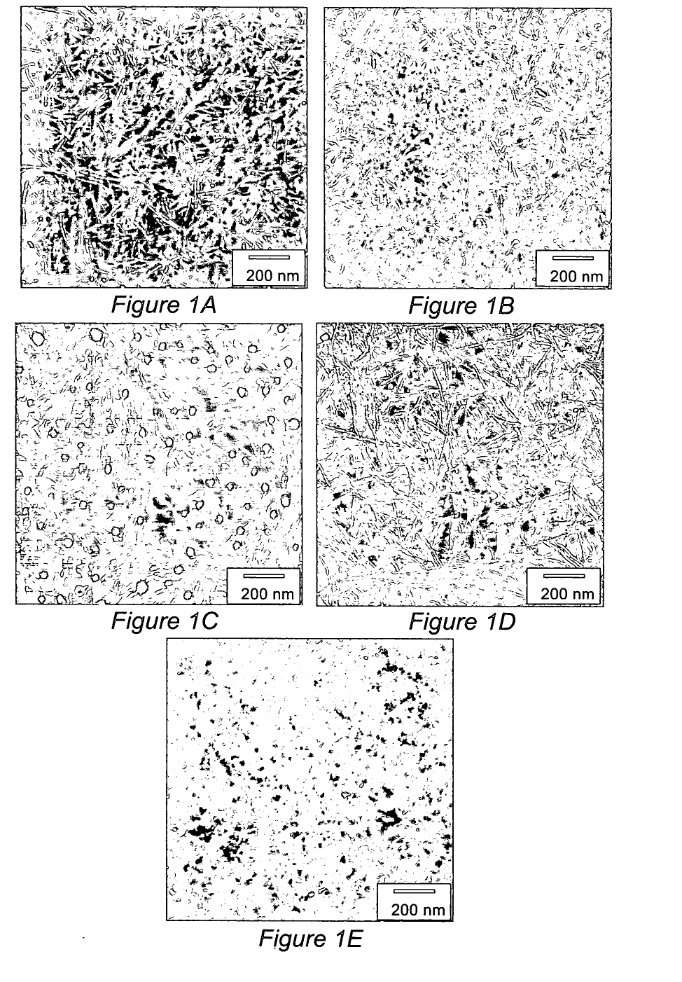

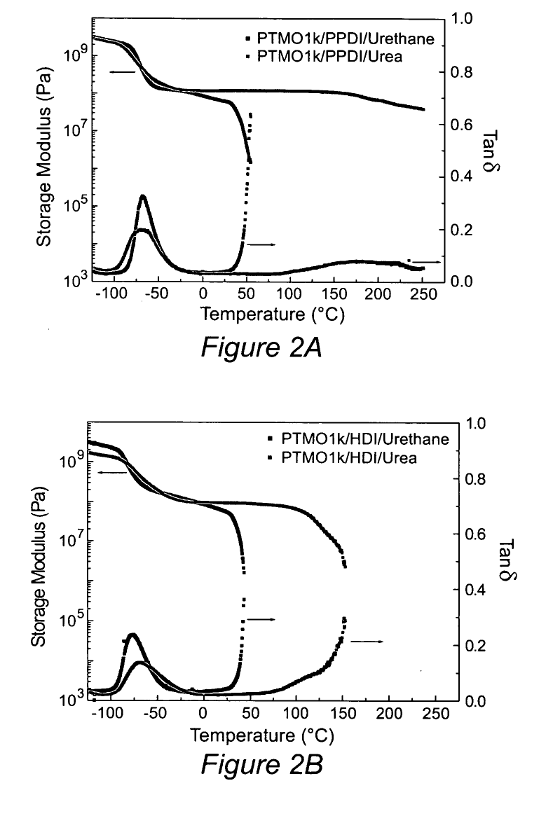

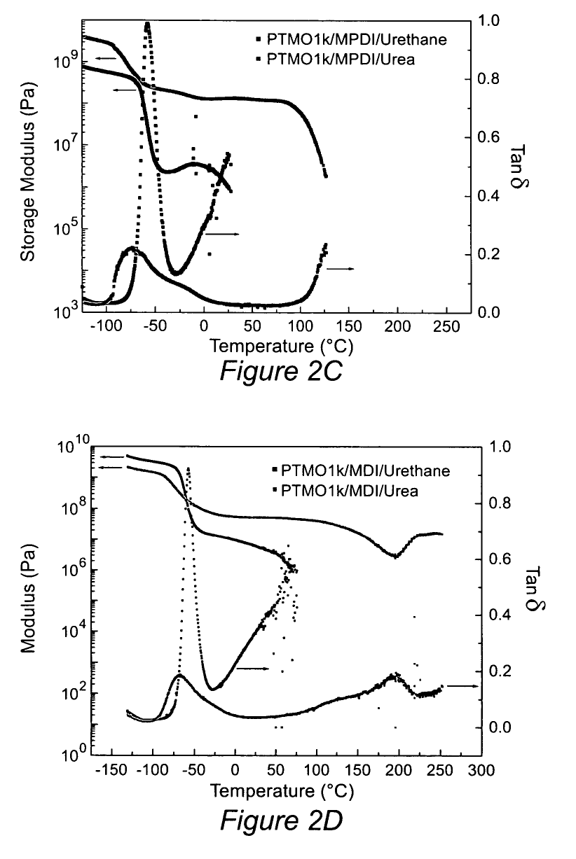

A list of segmented polyurethanes and polyureas prepared through the stoichiometric reactions of poly(tetramethylene oxide)glycol (PTMO) with Mn=975 g/mol and aminopropyl terminated poly(tetramethylene oxide) (PTMO) with Mn=1100 g/mol, their chemical compositions and number and weight average molecular weights are provided on Tables 1 and 2. Chemical compositions, GPC molecular weights and stress-strain properties of segmented copolymers based on an amine terminated PDMS oligomer with Mn=10,800 g/mol are provided on Tables 3 and 4 respectively. FIG. 1 gives the tapping-mode AFM phase images of various representative copolymers PTMO1k/PPDI/Urethane (FIG. 1A); PTMO1k/PPDI/Urea (FIG. 1B); PTMO1k/HDI/Urethane (FIG. 1C); PTMO1k/HDI/Urea (FIG. 1D); PTMO1k/MDI/Urea (FIG. 1E). FIG. 2 provides the dynamic mechanical behaviors of homologous segmented polyureas and polyurethanes based on the same diisocyanate and PTMO soft segments PPDI based copolymers (FIG. 1A), HDI based copolymers (FIG. 1B), MPDI based copolymers (FIG. 1C), MDI based copolymers (FIG. 1D). Mechanical properties of selected copolymers are summarized on Table 5.

TABLE 1
Segmented polyurethanes based on stoichiometric
reactions of hydroxy terminated PTMO (Mn = 973
g/mol) and various diisocyanates

| | Diisocyanate | | PTMO | | | |
|---|---|---|---|---|---|---|
| Sample | | Amount | Amount | HS | Mn | Mw |
| code | Type | (g) | (g) | (wt %) | (g/mol) | (g/mol) |
| PU-87 | PPDI | 1.60 | 9.73 | 14.1 | 30,000 | 41,500 |
| PU-131 | PPDI | 1.09 | 6.63 | 14.1 | 46,500 | 70,000 |
| PU-116 | MPDI | 1.08 | 6.56 | 14.1 | 57,000 | 129,000 |
| PU-156 | MPDI | 1.16 | 7.05 | 14.1 | 56,200 | 123,600 |
| PU-94 | TDI | 3.00 | 14.90 | 15.2 | 36,000 | 52,000 |
| PU-135 | MDI | 2.50 | 9.74 | 20.4 | 47,800 | 82,400 |
| PU-129 | HMDI | 2.78 | 10.31 | 21.2 | | |
| PU-173 | HDI | 1.68 | 9.73 | 14.7 | | |

TABLE 2
Segmented polyureas based on stoichiometric reactions of amine
terminated PTMO (Mn = 1100 g/mol) and various diisocyanates

| | Diisocyanate | | PTMO | | | |
|---|---|---|---|---|---|---|
| Sample | | Amount | Amount | HS | Mn | Mw |
| code | Type | (g) | (g) | (wt %) | (g/mol) | (g/mol) |
| PU-123 | PPDI | 0.85 | 5.84 | 12.7 | 35,700 | 84,100 |
| PU-128 | PPDI | 0.66 | 4.54 | 12.7 | 43,400 | 91,600 |
| PU-124 | MPDI | 0.84 | 5.73 | 12.8 | | |
| PU-125 | TDI | 1.59 | 10.07 | 13.6 | 41,300 | 91,300 |
| PU-127 | TDI | 0.90 | 5.69 | 13.7 | | |
| PU-136 | MDI | 2.52 | 11.07 | 18.5 | 59,500 | 200,800 |
| PU-84 | HMDI | 2.65 | 11.05 | 19.3 | 67,100 | 273,000 |
| PU-143 | HMDI | 3.20 | 13.42 | 19.3 | 50,000 | 129,000 |
| PU-85 | IPDI | 3.36 | 16.52 | 16.9 | 65.400 | 153,500 |
| PU-173-a | HDI | 1.86 | 12.18 | 13.3 | | |

TABLE 3
Segmented polyureas based on stoichiometric reactions of
PDMS (Mn = 10,800 g/mol) and various diisocyanates

| | Diisocyanate | | PDMS | | | |
|---|---|---|---|---|---|---|
| Sample | | Amount | Amount | HS | Mn | Mw |
| code | Type | (g) | (g) | (wt %) | (g/mol) | (g/mol) |
| PU-138 | PPDI | 0.1602 | 10.82 | 1.5 | 730,000 | 1,200,000 |
| PU-140 | TDI | 0.1871 | 11.46 | 1.6 | 920,000 | 1,825,000 |
| PU-141 | MDI | 0.3280 | 14.18 | 2.3 | 1,430,000 | 2,080,000 |
| PU-150 | HMDI | 0.3801 | 15.66 | 2.4 | | |

TABLE 4
Tensile behavior of PDMS-10,800 + Single isocyanate copolymers
(Crosshead speed 25 mm/min)

| | | Modulus | Tensile strength | Elongation |
|---|---|---|---|---|
| Sample | Isocy | (MPa) | (MPa) | (%) |
| IY-PU-138 | PPDI | 2.37 | 3.95 | 990 |
| IY-PU-140 | TDI | 0.95 | 2.45 | 1840 |
| IY-PU-141 | MDI | 1.92 | 3.07 | 900 |
| IY-PU-150 | HMDI | 0.95 | 1.26 | 600 |

TABLE 5
Mechanical properties of segmented polyurethane
and polyurea copolymers

| | Young's | Tensile | Elongation |
|---|---|---|---|
| | Modulus | Strength | at Break |
| Sample | (MPa) | (MPa) | (%) |
| PTMO1k/PPDI/Urethane | 26.5 ± 7.0 | 10.2 ± 1.5 | 1000 ± 130 |
| PTMO1k/PPDI/Urea | 75.6 ± 4.4 | 19.4 ± 1.8 | 540 ± 40 |
| PTMO1k/PPDI/Urea | 58.5 ± 5.2 | 26.5 ± 2.6 | 930 ± 110 |
| (Compression molded*) | | | |
| PTMO1k/MPDI/Urethane | N.A. | N.A. | N.A. |
| PTMO1k/MPDI/Urea | 63.1 ± 8.5 | 5.40 ± 0.90 | 700 ± 190 |
| PTMO1k/PPDI- | 12.0 ± 1.1 | 4.20 ± 0.54 | 1400 ± 190 |
| MPDI/Urethane | | | |
| PTMO1k/TDI/Urethane | N.A. | N.A. | N.A. |
| PTMO1k/TDI/Urea | 51.8 ± 4.0 | 12.3 ± 2.8 | 750 ± 150 |
| PTMO1k/MDI/Urethane | N.A. | N.A. | N.A. |
| PTMO1k/MDI/Urea | 45.5 ± 11.3 | 16.9 ± 5.1 | 660 ± 190 |
| PTMO1k/HMDI/Urethane | N.A. | N.A. | N.A. |
| PTMO1k/HMDI/Urea | 5.60 ± 0.10 | 26.5 ± 3.3 | 1090 ± 35 |
| PTMO1k/HDI/Urethane | 24.6 ± 2.3 | 22.8 ± 3.5 | 1380 ± 180 |
| PTMO1k/HDI/Urea | 120.0 ± 24.7 | 24.7 ± 6.3 | 760 ± 70 |

*Sample compression molded at 210° C. under a load of 6000 kgf, thereafter removed from the press and allowed to cool to ambient temperature.

### INVENTIVE EXAMPLE 2

(Chain Symmetry and Hydrogen Bonding in Segmented Copolymers with Monodisperse Hard Segments; Segmented polyurethane and polyurea copolymers Based on pPDI and mPDI)

The present inventors have extended and applied to synthetic technology, certain observations made for naturally occurring materials. As is well documented, hydrogen bonding and crystallization are two factors that strongly influence the morphology and properties of natural polymers, such as poly(nucleic acids) (e.g. DNA, RNA), proteins (e.g. spider silk), cellulose, polysaccharides, lipids, etc. (Jeffrey G A, Saenger W, Hydrogen bonding in biological systems (Berlin: Springer-Verlag), 1994; Alper J, Science 2002; 297: 329-331; Vogel V, MRS Bulletin 2002; 27: 972-980.)

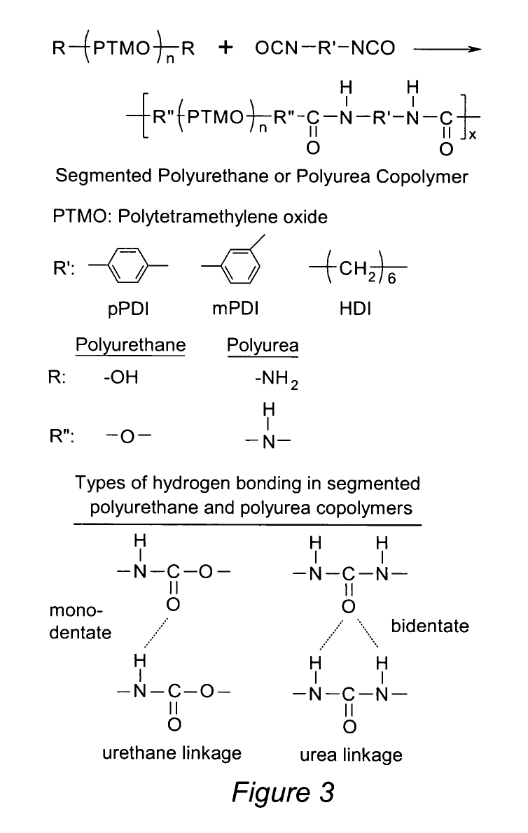

Inspired by such features observed in natural materials, the present inventors discovered that, in synthetic segmented copolymer production, a proper choice of the type of hydrogen bonding and the level of chain symmetry produces, without chain extension, segmented polyurethane and polyurea copolymers that would still display strong microphase separation. Copolymers were synthesized copolymers using a one-step procedure where we reacted equimolar amounts of a selected diisocyanate with dihydroxy or diamine terminated poly(tetramethylene oxide) (PTMO) oligomer of <Mₙ> 975 and 1100 g/mol thereby promoting either segmented polyurethane or polyurea segment copolymers, respectively. Thus, the resulting segmented copolymers had PTMO as the SS and a uniform length (monodisperse) HS based upon only a single diisocyanate molecule. We used the diisocyanates, para-phenylene diisocyanate (pPDI), meta-phenylene diisocyanate (mPDI), hexamethylene diisocyanate (HDI), toluene diisocyanate (TDI), diphenyl methane diisocyanate (MDI), hydrogenated MDI (HMDI), and 1,4 cyclohexyl diisocyanate (CHDI) to fully examine the role played by the level of HS symmetry. Using dihydroxy and diamine terminated PTMO, respective synthesis was conducted of analogous polyurethanes and polyureas, respectively. The synthesis strategy presented in FIG. 3 resulted in copolymers with ca. 14 wt % HS content.

Experimental

Materials: 1,4-Phenylene diisocyanate (pPDI) and 1,3-phenylene diisocyanate (mPDI) were purchased from Aldrich. The diisocyanate mPDI was used as received, while pPDI was sublimed at 70° C. Purities of diisocyanates were better than 99.5%. α,ω-Aminopropyl terminated poly(tetramethylene oxide) (PTMO) with <Mₙ> 1100 g/mol was purchased from Aldrich. Poly(tetramethylene oxide)glycol, with <Mₙ> 975 g/mol was provided by DuPont. Reagent grade dimethylformamide (DMF) was purchased from Aldrich and used as received.

Polymer synthesis: Polymerizations were conducted in three-neck, round bottom, Pyrex reaction flasks equipped with an overhead stirrer, addition funnel and nitrogen inlet. All copolymers were prepared by reacting equimolar amounts of a selected diisocyanate and PTMO oligomer. No chain extenders were used. Segmented polyurea copolymers were prepared at room temperature in DMF at a concentration of about 20 wt % solids, by the dropwise addition of PTMO solution onto the diisocyanate solution, under strong agitation. Polyurethanes were prepared in DMF at 60° C. Completion of reactions was determined by monitoring the disappearance of the isocyanate absorption peak around 2270 cm⁻¹ with a FTIR spectrophotometer.

Polymer films ca. 1 mm thick were obtained by pouring the solutions into Teflon molds. The molds were covered with a glass Petri dish to slow down the solvent evaporation and placed in an oven maintained at 60° C. After evaporation of the solvent, the molds were placed in a vacuum oven at 60° C. for complete drying, which was monitored gravimetrically. The resulting films were then removed from the Teflon molds and stored under vacuum at room temperature until needed for testing. Portions of these films were also compression molded in order to check their melt processability and to compare their solid-state behavior with that of their solution cast analog.

Also shown in FIG. 3 are the two principal types of hydrogen bonding that result from urethane and urea linkages. The former give rise to monodentate hydrogen bonding, which has a reported bond energy of 18.4 kJ/mol, whereas the latter result in bidentate hydrogen bonding with higher bond energy of 21.8 kJ/mol. Yilgor E, Burgaz E, Yurtsever E, Yilgor I, Polymer 2001; 41: 849-857.

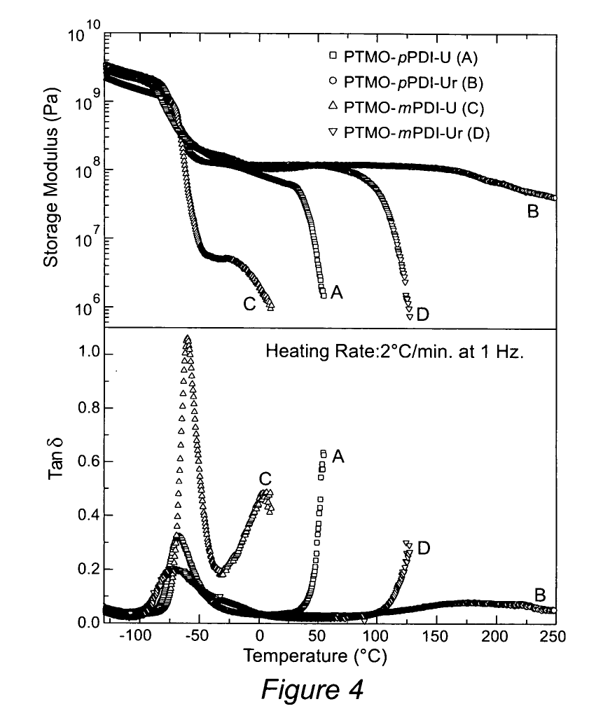

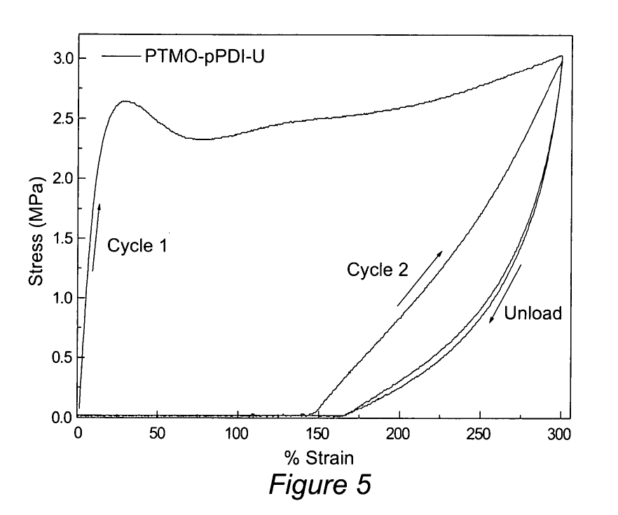

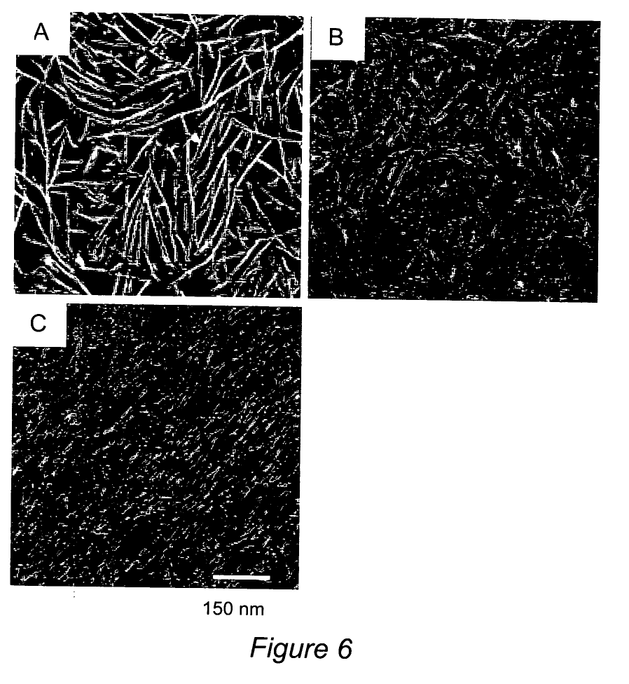

The temperature dependent storage modulus, E′ and Tan δ responses of pPDI and mPDI based segmented polyurethane copolymers and their polyurea counterparts are presented in FIG. 4. The dynamic mechanical analysis was conducted on films cast from 20 wt % solutions in DMF. The samples are identified by the nomenclature: soft segment-diisocyanate-copolymer type, U for polyurethane or Ur for polyurea. Focusing on E′, as expected, below the SS glass transition, between −75 to −60° C. all four samples behave as rigid solids. Following this transition is a rubbery plateau whose breadth, average plateau modulus value, and temperature sensitivity depend upon the level of HS symmetry and the nature of hydrogen bonding network within the hard phase. The rubbery plateau of PTMO-pPDI-U, although narrow and temperature sensitive, displays an average E′ value of ca. 10⁸ Pa. Such high E′ values above the SS T_{g} are more commonly exhibited by conventional chain extended polyurethanes with a distinctly higher HS content (Barikani M, Hepburn C. Cellular Poly 1987; 6: 41-45) than the 14 wt % present in the inventive copolymers of this Example. The high average E′ value strongly alludes to the presence of long-range connectivity of the HS and the percolation of the hard phase through the soft matrix. The tensile behavior of this material (FIG. 5) corresponds to such a view. When stretched uniaxially at ambient temperature this sample distinctly necks and displays a yield point, which must arise due to the break-up of the percolated hard phase. Consequently, when the applied load is released, it displays large permanent set and mechanical hysteresis. However, during the subsequent cyclic deformation, immediately following the first, the sample displays typical elastomeric behavior due to the inability of the microstructure to fully ‘heal’ before another deformation cycle is initiated. This elastomeric behavior further strengthens our argument that this system displays good microphase separation because a mixed SS-HS material would certainly not be expected to display good recovery following the second or higher deformations at this temperature. Tapping mode atomic force microscopy (AFM) provides direct confirmation of the HS phase morphology. This sample's phase image (FIG. 6A) clearly displays a well-defined percolated HS phase that has developed in the form of ribbon-like hard domains of high aspect ratio. These ribbons are randomly dispersed throughout the SS phase, which dominates the composition and hence forms the continuous matrix. In addition to the HS connectivity, crystallization of the symmetric pPDI based HS phase also contributes towards elevating the average value of the rubbery plateau E′. The crystallization of the symmetric pPDI based HS phase was confirmed by DSC as well as WAXS (not shown). Two convoluted endothermic peaks were noted in the DSC heating scan of PTMO-pPDI-U. These peaks were centered at 43 and 50° C. and correspond to the melting transition of the pPDI based HS phase. The melting point of pure pPDI is 97° C. In addition, the 2D WAXS of PTMO-pPDI-U indicated a sharp azimuthally independent reflection at 4.1 Å.

When the monodentate hydrogen bonded network is replaced by the stronger bidentate network, thereby resulting in the polyurea copolymer PTMO-pPDI-Ur, the upper limit of the rubbery plateau extends to considerably higher temperatures as expected. In addition, it also exhibits a Young's modulus of 75 MPa and a tensile strength of 26 MPa, which are respectively a factor of three and two higher than of the polyurethane counterpart, PTMO-pPDI-U. Similar to its polyurethane analog, the polyurea, PTMO-pPDI-Ur also exhibits neck formation and a yield point in its stress-strain response at ambient temperature. Another important advantage conferred by the low HS content in PTMO-pPDI-Ur is that the copolymer can be easily remolded (at 210° C.) without degradation or chemical cross-linking to generate a transparent homogeneous film that possesses comparable physical property behavior and morphology. We conducted tensile tests of the sample PTMO-pPDI-Ur before and after compression molding. The samples exhibited comparable Young's modulus, tensile strength, and elongation at break, thereby indicating that degradation or chemical cross-linking upon remolding was limited, if any. In contrast, under similar thermal molding conditions, the well-known commercial spandex, which is a segmented polyurethaneurea with greater than 80 wt % elastomeric component, begins to lose structural integrity and is not moldable. For this reason spandex, which possesses much more extensive bidentate hydrogen bonding, requires solution processing.

An understanding of the influence of the HS symmetry on the E′ response can be gained by comparing PTMO-pPDI-U with PTMO-mPDI-U. In the latter copolymer, the SS glass transition results in a precipitous drop in its E′. A very narrow rubbery plateau extends thereafter and its average plateau modulus is approximately an order of magnitude lower than that of PTMO-pPDI-U. Such an inferior service window response of PTMO-mPDI-U can be attributed to the absence of symmetry in the mPDI based HS which hinders their long-range connectivity. We also did not observe any hard phase crystallinity in this sample by either WAXS or DSC. In fact, the solution cast film of PTMO-mPDI-U is tacky at ambient temperature whereas that of PTMO-pPDI-U is distinctly non-tacky. Moreover, the solution cast film of the copolymer synthesized by utilizing an equal weight fraction mixture of mPDI and pPDI is also very tacky. This observation further confirms the importance of HS symmetry in enabling their long-range connectivity in copolymers having low HS content. Substitution of the monodentate hydrogen bond network in PTMO-mPDI-U with its bidentate counterpart in the segmented polyurea PTMO-mPDI-Ur raises the average plateau modulus of the copolymer nearly up to the level of the symmetric pPDI based samples. DSC analysis demonstrated that the hard phase of this sample was also able to crystallize. Moreover, its rubbery plateau is much broader than the polyurethane, PTMO-pPDI-U. Such behavior indicates that in addition to HS symmetry, the nature of the hydrogen bonded network within the hard phase distinctly influences HS long-range connectivity (see below) and hard phase crystallizability. Not surprisingly, PTMO-pPDI-Ur, which has both bidentate hydrogen bonding and a symmetric HS, exhibits the most enhanced service window response amongst the series addressed in FIG. 3.

The HS structure and its type of hydrogen bonding strongly influence the potential crystallizability and cohesiveness of the hard domains formed. This fact is evident from the Tan δ response (FIG. 4). Here we note that with the exception of PTMO-mPDI-U, the peak value of Tan δ is maintained between 0.2-0.3, whereas that for the remaining sample is above 1.0. While at first the higher Tan δ value of the sample might be thought to imply better microphase separation, this is not the case based on the obvious clear sharp microphase separated AFM images of the other three materials to be discussed shortly. Indeed, WAXS, SAXS, and DSC data, not shown here, directly support the AFM results. Furthermore, one observes that PTMO-mPDI-U exhibits a very short rubbery plateau and then undergoes viscous flow below room temperature, thereby suggesting that it has relatively little microphase separation or if it does, the HS phase is not cohesive enough to enable an extended rubbery plateau before the HS softens and flow occurs. In addition, SAXS and DSC also did not indicate any microphase separation. On the other hand the cause of the surprisingly depressed Tan δ peak of the three samples that display sharp microphase separation is believed to be due to the strong restrictions placed on the mobility of the SS phase by the rigid percolated HS that are covalently bonded to the relatively low MW (ca. 1000 g/mol) SS.

As indicated above, we also used tapping-mode AFM to confirm the presence of a percolated HS phase in some of the copolymers (FIG. 6). As noted above, the sample PTMO-pPDI-U (FIG. 6A) exhibits long ribbon-like bright regions that are the hard domains. Furthermore, there appears to be little to no sign of branching by the HS ribbon phase. The average width of these ribbons determined by AFM is ca. 30 Å. Such a morphology strongly suggests that the HS, which consist of only a single diisocyanate-derived moiety, pack perpendicular to the long axis of the ribbons. Aneja and Wilkes have also noted similar packing in PTMO based polyurethanes with uniform HS length. Aneja et al. 2003, supra. The hard domains in PTMO-pPDI-U are semicrystalline (see above) and their connectivity is facilitated by the HS's ability to establish a hydrogen bonded network; such connectivity in turn results in the percolation of the HS through the soft matrix. The calculated molecular length of the HS, which includes the two urethane linkages and the link between them, in PTMO-pPDI-U is ca. 10 Å. The difference between the observed width of the ribbons and the calculated HS length is believed to arise because portions of the SS at the interface with the hard phase experience considerable restrictions to their mobility. Therefore, in this more rigid interfacial region the portions of the included SS also appear bright in the phase image. The general morphology of the segmented polyurea PTMO-pPDI-Ur (FIG. 6B) is similar to that of its polyurethane counterpart (FIG. 6A).

Above the copolymer, PTMO-mPDI-U was characterized as tacky and its dynamic mechanical response suggested greater microphase mixing than in the other samples within the series. This conclusion is supported by AFM because we did not observe the presence of hard and soft regions in the phase image of this sample. On the other hand, its polyurea counterpart, namely PTMO-mPDI-Ur (FIG. 6C) clearly exhibits ribbon-like hard domains. This implies that the more cohesive bidentate hydrogen bonding of the urea groups can overcome the decreased symmetry of the mPDI diisocyanate in promoting HS connectivity. The morphologies of both polyurethane and polyurea copolymers based on the aliphatic CHDI and HDI, just like their pPDI counterparts, also consist of ribbon-like hard domains that percolate through the soft matrix.

The results of this Example undermine the belief widely held by others that it is necessary to employ chain extension to produce segmented polyurethane and polyurea copolymers with useful structural properties. In particular, this Example demonstrates that non-chain extended segmented urea copolymers in which the HS is based on only a single diisocyanate molecule may exhibit properties, such as the breadth of the service window, the average plateau modulus, stiffness, tensile strength, and elongation at break that are similar to chain extended segmented copolymers that possess distinctly higher HS content, especially when HS symmetry and the nature of the hydrogen bonding are carefully controlled to achieve such improved performance in non-chain extended systems. The data of this Example provide strong evidence for the controlling role played by the symmetry of the hard segment in morphology development in polyurethanes and new direction for the production of thermoplastic segmented urea copolymers that display a considerable thermal range for their service window yet be solution- as well as melt-processable.

In this Example, thermoplastic segmented polyurethane and polyurea copolymers whose monodisperse hard segments are based on only a single diisocyanate molecule are constructed. The solid-state structure-property behavior of these materials demonstrates that a proper selection of the level of symmetry and/or cohesiveness of the hard microdomains may allow elimination of the traditional requirement of chain extension to obtain melt processable segmented urethane, and more specifically, urea copolymers with useful structural properties.

While the invention has been described in terms of its preferred embodiments, those skilled in the art will recognize that the invention can be practiced with modification within the spirit and scope of the appended claims.

1. A segmented thermoplastic polyurea, polyurethane, or polyurethaneurea, made by the process of reacting in the absence of chain extenders stoichiometric amounts of one or more hydroxyl or amine end capped polymeric or oligomeric soft segments which lack siloxane with one or more single molecule, non-polymeric, non-oligomeric aromatic or aliphatic diisocyanates, whereby the reaction forms polyurea or polyurethane hard segments directly adjacent to polymeric or oligomeric soft segments.

2. The segmented thermoplastic polyurea, polyurethane, or polyurethaneurea of claim 1 wherein said one or more aromatic or aliphatic diisocyanates have the general structure OCN—R—NCO, where R is an alkyl, aryl, or aralkyl moiety having 4-20 carbon atoms.

3. The segmented thermoplastic polyurea, polyurethane, or polyurethaneurea of claim 1 wherein one of said one or more aromatic or aliphatic diisocyanates is an aliphatic diisocyanate and is selected from the group consisting of 1,4-cyclohexyldiisocyanate, bis(4-isocyanatocyclohexyl)methane, 1,6-hexamethylene diisocyanate, and isophorone diisocyanate.

4. The segmented thermoplastic polyurea, polyurethane, or polyurethaneurea of claim 1 wherein one of said one or more aromatic or aliphatic diisocyanates is an aromatic diisocyanate and is selected from the group consisting of p-phenylene diisocyanate, m-phenylene diisocyanate, 1,3-Bis(isocyanatoisopropyl)benzene, 2-4-tolylene diisocyanate, 2,6-tolylene diisocyanate, 4,4′-phenylene diisocyanate, and naphthalene diisocyanate.

5. The segmented thermoplastic polyurea, polyurethane, or polyurethaneurea of claim 1 wherein said polyurea or polyurethane hard segments constitute less than 5% by weight of said segmented thermoplastic polyurea, polyurethane or polyurethane utea.

6. The segmented thermoplastic polyurea, polyurethane, or polyurethaneurea of claim 1 wherein said polymeric or oligomeric soft segments include at least one aliphatic polyether.

7. The segmented thermoplastic polyurea, polyurethane, or polyurethaneurea of claim 1 wherein said polymeric or oligomeric soft segments include at least one aliphatic polyester glycol.

8. The segmented thermoplastic polyurea, polyurethane or polyurethaneurea of claim 1 wherein said polymeric or oligomeric soft segments include one or more of poly(ethylene oxide), poly(propylene oxide), poly(tetramethylene oxide), polydimethylsiloxane, and combinations thereof.

9. The segmented thermoplastic polyurea, polyurethane or polyurethaneurea of claim 8 wherein said polymeric or oligomeric soft segments have a number average molecular weight ranging from 500 to 2500 g/mol.

10. The segmented thermoplastic polyurea, polyurethane or polyurethaneurea of claim 8 wherein said polymeric or oligomeric soft segments include polydimethylsiloxane having a number average molecular weight ranging from 7,000 to 12,000 g/mole.

11. The segmented thermoplastic polyurea, polyurethane, or polyurethaneurea of claim 1 wherein said polymeric or oligomeric soft segments include one or more of telechelic, hydrosy or amine terminated, polybutadiene, polyisoprene, hydrogenated polybutadiene, hydrogenated polyisoprene or polyisobutylene.

12. The segmented thermoplastic polyurea, polyurethane, or polyurethaneurea of claim 1 wherein at least one of said one or more hydroxyl or amine end capped polymeric or oligomeric soft segments have the general formula HO—(R—O—)ₓ—H, H₂N—R₁—(R—O—)ₓ—NH₂, or HR₃N—R₂—(R—O—)ₓ—R₂—NR₃H, where R, R₁, R₂ and R₃ are the same or different from each other and each are linear or branched alkyls having 2 to 20 carbon atoms, and where x ranges from 5 to 300.

13. The segmented thermoplastic polyurea, polyurethane, or polyurethaneurea of claim 1 wherein at least one of said one or more hydroxyl or amine end capped polymeric or oligomeric soft segments have the general formula HO—R₄—(O—CO—R₅—CO—O—R₄)ₓ—OH where R₄ and R₅ may be the same or different and represent linear or branched alkyls with 2 to 20 carbon atoms, and where x ranges from 5 to 300.

14. The segmented thermoplastic polyurea, polyurethane, or polyurethaneurea of claim 1 wherein at least one of said one or more hydroxyl or amine end capped polymeric or oligomeric soft segments have the general formula HO—(CH₂)ₓ—(CO—(CH₂)ₓ—O—)_{y}H where x ranges between 2 and 10, and where y ranges between 5 and 300.

15. The segmented thermoplastic polyurea, polyurethane, or polyurethaneurea of claim 1 wherein said one or more hydroxyl or amine end capped polymeric or oligomeric soft segments include at least one hydroxyl end capped polymeric or oligomeric soft segment and at least one amine end capped polymeric or oligomeric soft segment.

16. The segmented thermoplastic polyurea, polyurethane, or polyurethaneurea of claim 15 wherein said one or more hydroxyl or amine end capped polymeric or oligomeric soft segments includes a polydimethylsiloxane, and at least one of a poly(ethylene oxide), a poly(propylene oxide), and a poly(tetramethylene oxide).

17. A method of forming segmented thermoplastic polyurea, polyurethane, or polyurethaneurea, comprising the step of reacting in the absence of chain extenders stoichiometric amounts of one or more hydroxyl or amine end capped polymeric or oligomeric soft segments which lack siloxane with one or more single molecule, non-polymeric, non-oligomeric aromatic or aliphatic diisocyanates, whereby polyurea or polyurethane hard segments are formed directly adjacent to polymeric or oligomeric soft segments.

18. The method of claim 17 wherein said reacting step is performed in the presence of a solvent.

19. The method of claim 17 wherein said reacting step is performed using batch or reactive extrusion processes.

20. The method of claim 17 further comprising the step of monitoring for the disappearance of an isocyanate peak in an infra red spectrum.

21. The method of claim 17 further comprising the step of heating during said reacting step.

22. The method of claim 17 further comprising the step of mechanically agitating a reaction mixture during said reacting step.

23. The method of claim 17 wherein said reacting step is performed in an inert atmosphere.
